(19) United States
(12) Patent Application Publication
(10) Pub. No.: US 2008/0023570 A1
(43) Pub. Date: Jan. 31, 2008

(54) Conductor-driving multi-hole micro sprinkle-nozzle and sprinkling cap made therewith

(75) Inventors: Ming-Te Tu, Taipei Hsien (TW); Chun-Chang Tsai, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Ming-Te TU

(21) Appl. No.: 11/492,997

(22) Filed: Jul. 26, 2006

(51) Int. Cl. B05B 1/08

(52) U.S. Cl. 239/102.1; 239/102.2; 239/552; 239/548

(57) ABSTRACT

A micro sprinkle-nozzle and a sprinkling cap made therewith, wherein the sprinkle-nozzle includes a conducting vibrator and a water container. The conducting vibrator is composed of a vibrating ring in the form of a hollow ring made of a conductive material, and a metal membrane made of a conductive film, the specific portion of which has sprinkling holes distributed in a manner of dot matrix. While the vibrating ring is adhered to the metal membrane, the vibrator is installed to a pipe top of a water container to accomplish a sprinkle-nozzle. The sprinkle-nozzle is installed to the front end of the peak with one end thereof connected to a water pouch which can be electrified to spray mist, thereby obtaining a sprinkling cap.

### BACKGROUND OF THE INVENTION

(a) Field of the Invention

The present invention relates to a micro sprinkle-nozzle and a cap design made therewith, particularly to a novel sprinkle-nozzle, the structure of which is excellent in a tiny volume which can allow application of the sprinkle-nozzle to the cap, such that the user can wear the cap and, meanwhile, enjoy the cooling feeling when the mist is spraying on the face.

(b) Description of the Prior Art

Generally, people used to wear a cap when conducting outdoor activities/sports, particularly under hot weather, the cap can be served as a sunshade. A conventional leisure cap has a peak for sun shading purposes. However, whenever the heat blows head-on, one will still feel hot. Accordingly, there is a need in designing a micro sprinkle-nozzle that can spray out mist any time, and is tiny-sized, lightweight, water-saving, power-saving, and applicable to a cap, such that mist can constantly spray on the user's face to offer a cooling effect.

Accordingly, the micro sprinkle-nozzle has its specific value, and can improve the function of a conventional cap after the inventor's research and development.

### SUMMARY OF THE INVENTION

The primary object of the invention is to provide a conductor-driving multi-hole micro sprinkle-nozzle, and a cap made therewith. In the micro sprinkle-nozzle structure, the micro power can make the sprinkle-nozzle to spray mist, with the advantages that the sprinkle-nozzle is lightweight and tiny-sized, and that the water consumption is little.

The secondary object of the invention is to provide a conductor-driving multi-hole micro sprinkle-nozzle, and a cap made therewith. The micro sprinkle-nozzle can be installed at the cap, while a connecting pipe is provided at the inner rim of the cap to lead to a water pouch. Finally, a battery device with a switch is connected to the sprinkle-nozzle to accomplish a sprinkling cap.

To obtain the above objects, the sprinkle-nozzle according to the invention includes a conducting vibrator and a water container. The conducting vibrator is composed of a vibrating ring in the form of a hollow ring made of a conductive material, and a metal membrane made of a conductive film. While the vibrating ring is adhered to the metal membrane at a specific portion where sprinkling holes are distributed in a manner of dot matrix, the vibrator composed of the vibrating ring and the metal membrane is installed to a pipe top of a water container. After the vibrator is electrified, the metal membrane will repeat transforming in a manner of bending upwardly and downwardly, thereby the interior of the water container will be pressed, and water will spray out of the nozzle to accomplish a sprinkle-nozzle.

Furthermore, the micro sprinkle-nozzle is installed at the front end of the cap peak with one end thereof connected to a water pouch which can be electrified to spray mist, thereby obtaining a sprinkling cap.

To completely appreciate these and other objects of the present invention as well as the invention itself, all of which will become apparent to those skilled in the art, the following detailed description of the invention and the claims should be read in conjunction with the accompanying drawings.

### BRIEF DESCRIPTION OF THE DRAWINGS

FIG. 1 is an exploded view of the present invention.

FIG. 2 is a perspective view of the present invention.

FIG. 3 is a cut-away view of the sprinkle-nozzle according to the present invention.

FIG. 4 shows the sprinkle-nozzle which is sprinkling after being electrified according to the present invention.

FIG. 4A is a partially enlarged view of FIG. 4 according to the present invention.

FIG. 5 shows connection to a pipe rotator according to the present invention.

FIG. 6 shows the rotating directions of the sprinkle-nozzle after being connected to the pipe rotator according to the present invention.

FIG. 7 is a cut-away view as shown in FIG. 6 according to the present invention.

FIG. 8 is an exploded view showing application of the sprinkle-nozzle to form a sprinkling cap according to the present invention.

FIG. 9 is a perspective view showing application of the sprinkle-nozzle to form a sprinkling cap according to the present invention.

FIG. 10 is a partially cut-away view showing application of the sprinkle-nozzle to form a sprinkling cap according to the present invention.

FIG. 11 shows the status of use according to the present invention.

### DETAILED DESCRIPTION OF THE PREFERRED EMBODIMENTS

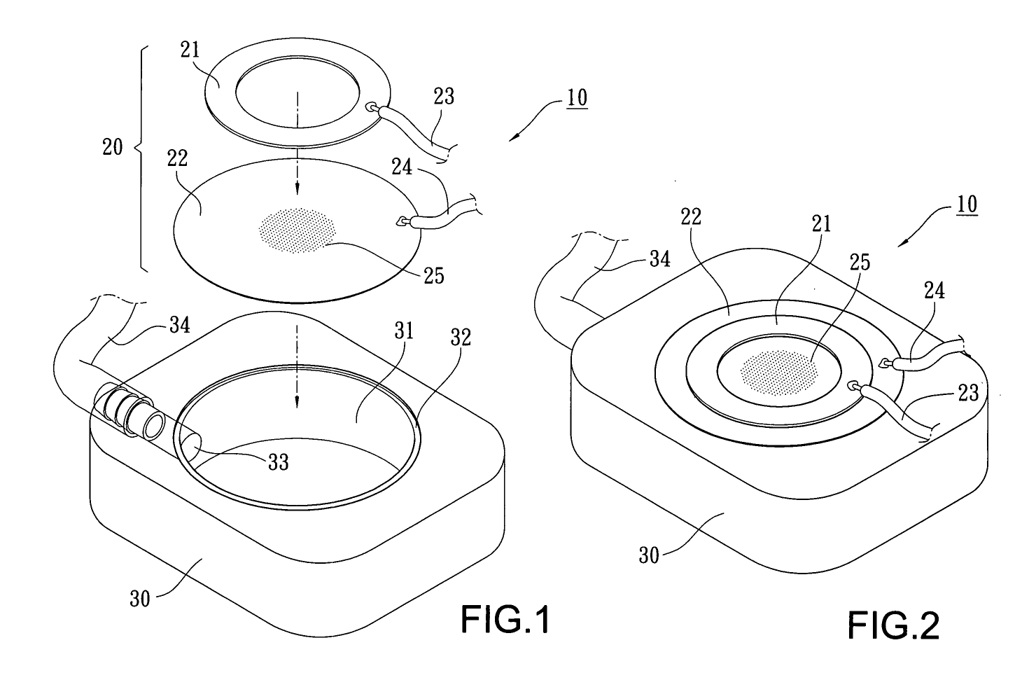

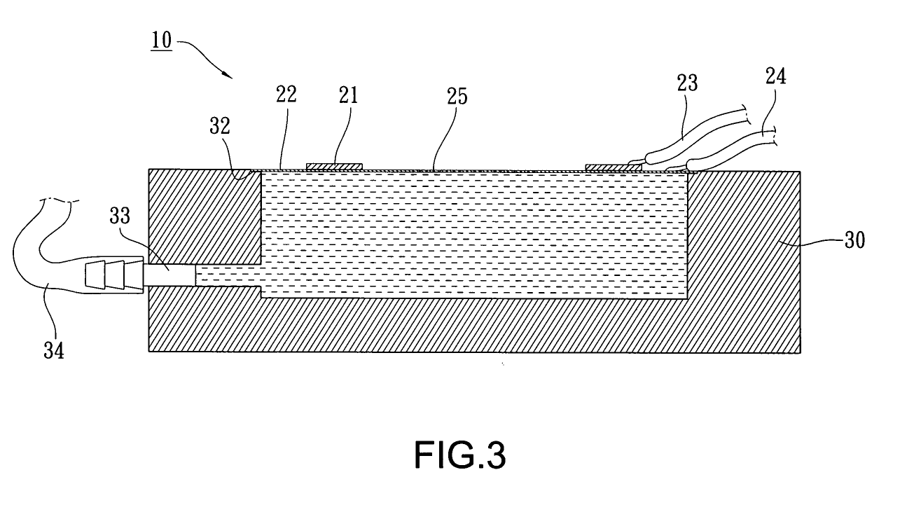

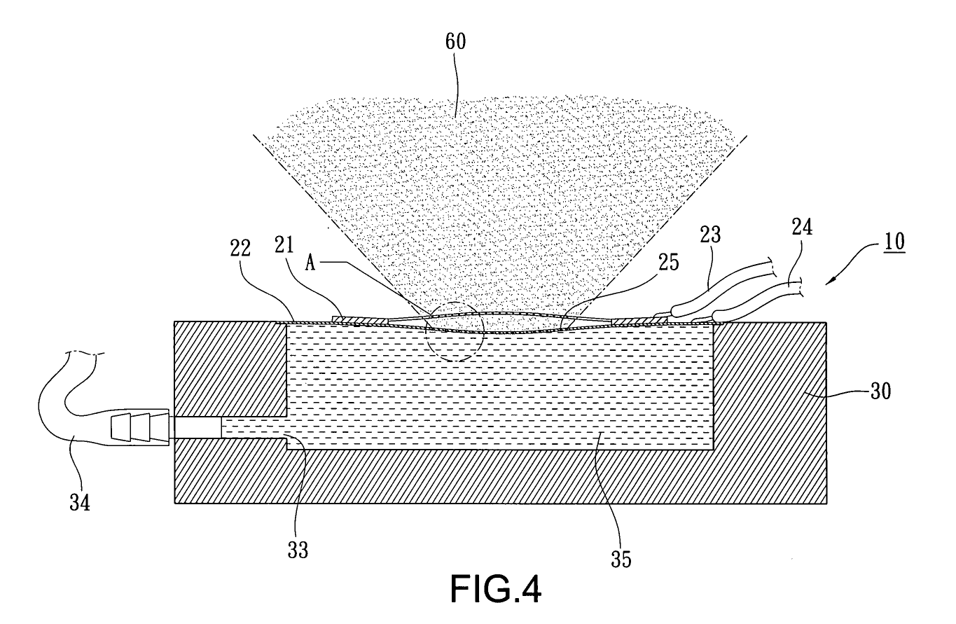

Referring to FIGS. 1 to 3, the conductor-driving multi-hole micro sprinkle-nozzle 10 according to the invention includes a vibrating ring 21, a metal membrane 22 and a water container 30. The vibrating ring 21 is adhered to the upper surface of the metal membrane 22, and is connected with a conducting cord 24. The central portion of the metal membrane 22 has a plurality of sprinkle holes 25 distributed in a manner of dot matrix. The thickness of the metal membrane 22 is preferably about 8 μm, and that of the vibrating ring 21 is preferably about 200-300 μm, while the diameter of the sprinkle hole 25 at the metal membrane 22 is about 34 μm, such that the vibrating ring 21 and the metal membrane 22 can be adhered and combined together to form a conducting vibrator 20, and subsequently combined to a cave 31 of the water container 30. The top edge of the cave 30 is provided with a step 32 for receiving the conducting vibrator 20. The rim of the connecting portion is sealed to obtain a sprinkle-nozzle 10. The cave 31 of the water container 30 is provided with a water inlet 33 combined with a water conduit 34 for connecting to the exterior.

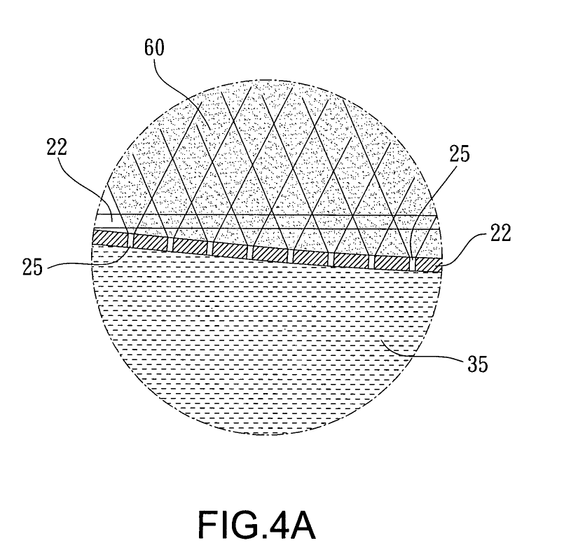

As shown in FIGS. 4 and 4A, after the sprinkle-nozzle 10 is electrified through conducting cords (23, 24), the conducting vibrator 20 will electrically resonate, thereby occurring a bending-format transformation on the metal membrane 22. Accordingly, the metal membrane 22 will vibrate upwardly and downwardly. Meanwhile, as the underside of the metal membrane 22 is the close cave 31 of the water container 30, when the metal membrane 22 rapidly vibrates in an upward and downward manner, the liquid 35 contained in the cave 31 will be repeatedly squeezed, and speedily spray out of the fine sprinkle holes 25 on the metal membrane 22. As the diameter of each sprinkle hole 25 is about 34 μm, the volume of the water sprayed out will be viewed like mist 60 (or smog).

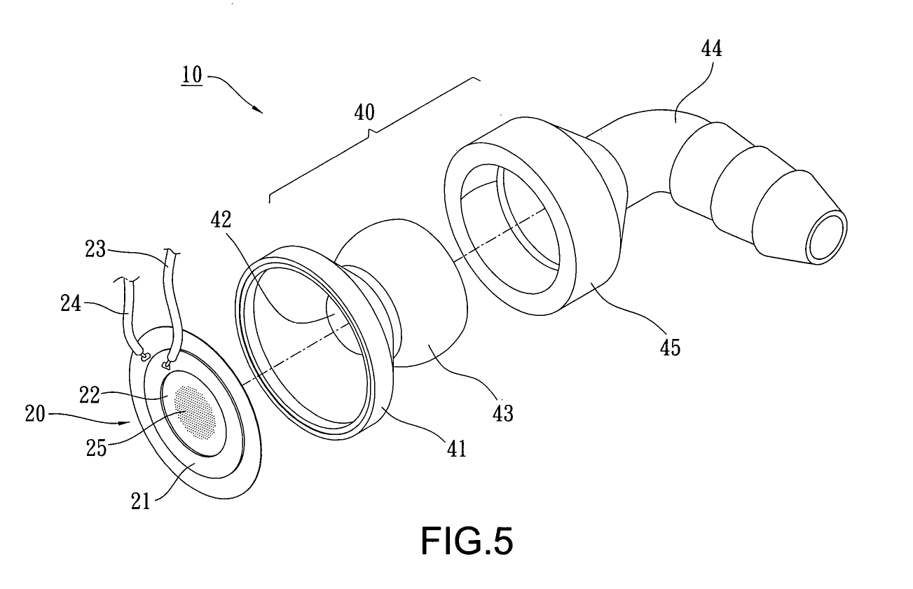

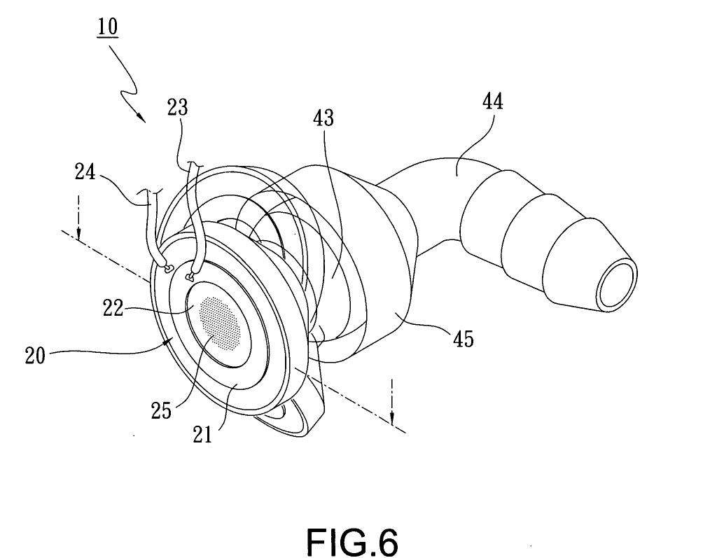

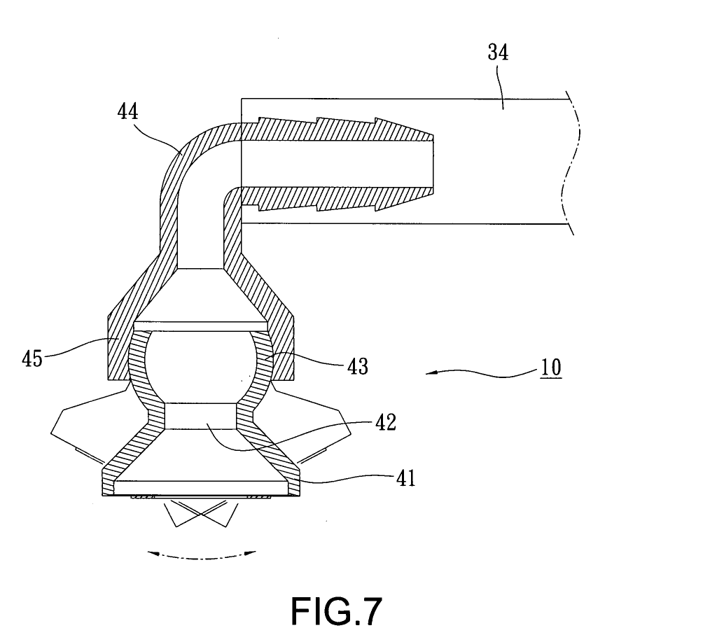

As shown in FIGS. 5 to 7, the conducting vibrator 20 according to the invention may combine with a pipe rotator 40. As shown in the preferred embodiment, the conducting vibrator 20 is disposed at the front end of a pipe base 41 which has a hollow path 42, and a ball housing 43 at the rear portion. A hollow connector 44 is provided with a holder 45 at the front end, such that the ball housing 43 can be plugged into the holder 45, and that the ball housing 43 can rotate within the holder 45 to change direction, thereby accomplishing a sprinkle-nozzle 10 with rotation purposes.

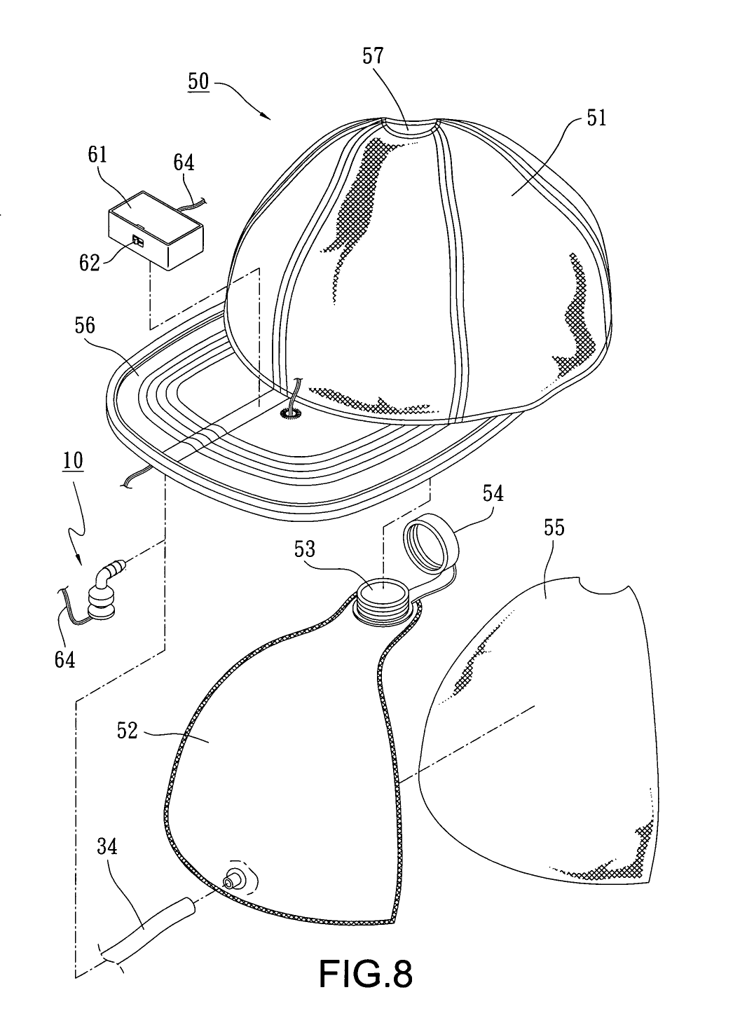

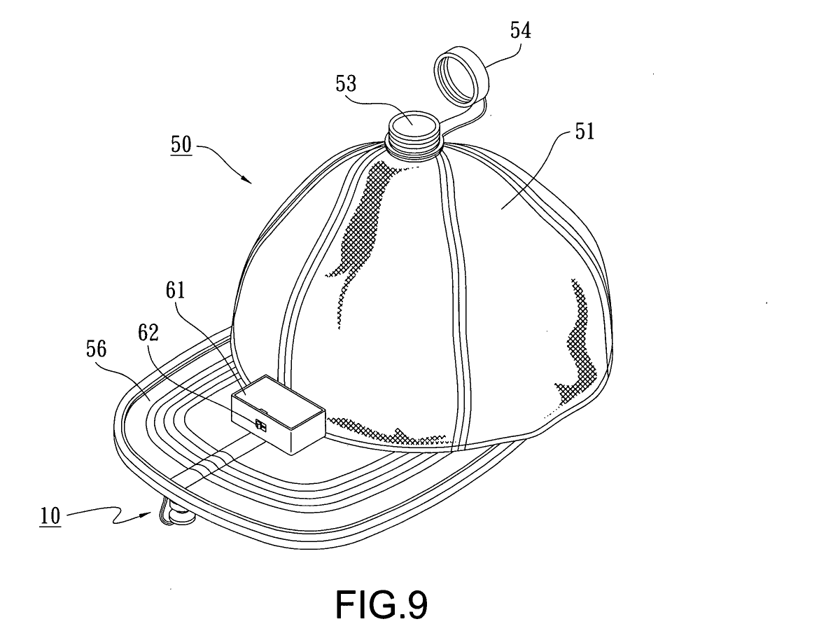

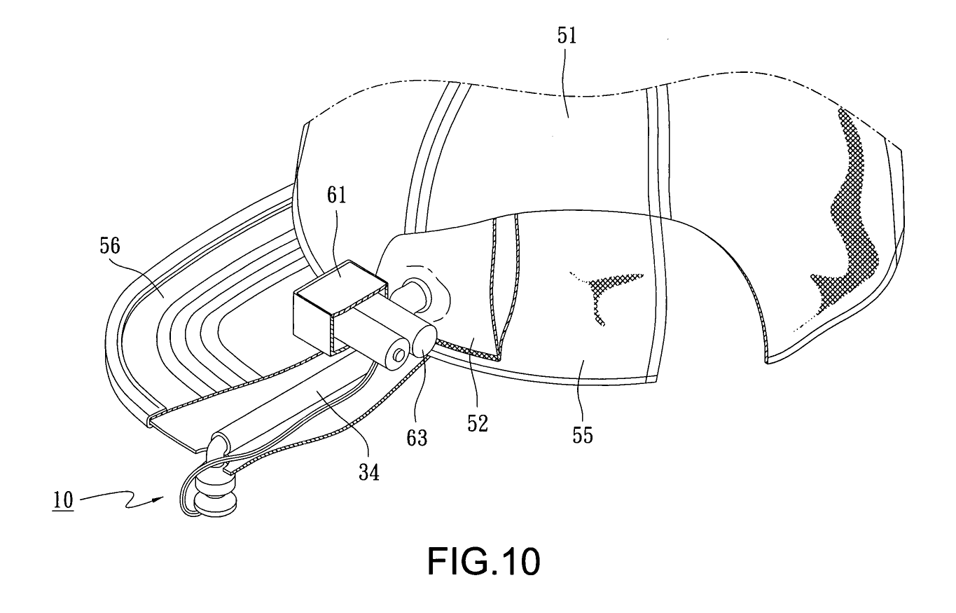

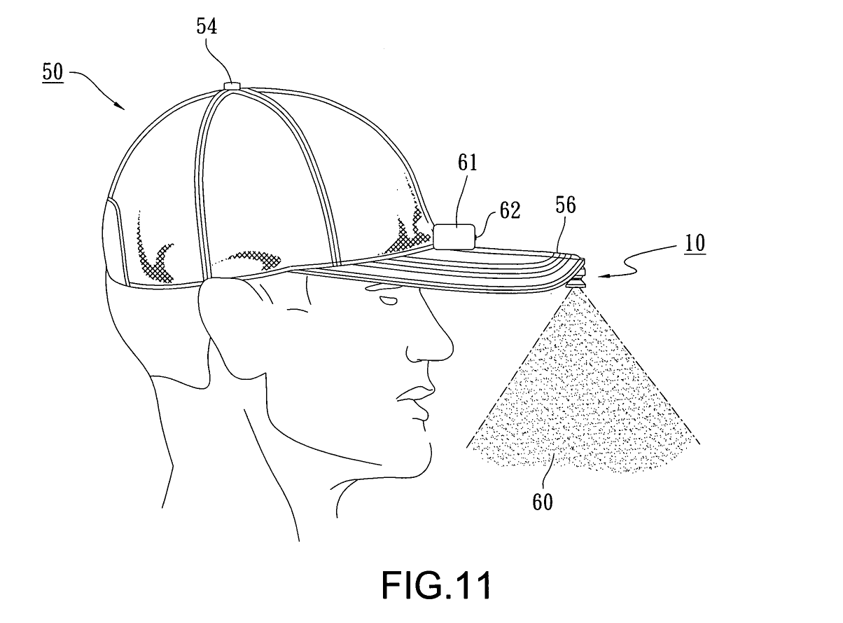

Referring to FIGS. 8 to 11, the sprinkle-nozzle 10 combined with a pipe rotator 40 can be applied to a cap to accomplish a sprinkling cap 50. In the preferred embodiment, the sprinkling cap 50 includes a cap 51, a water pouch 52 and a sprinkle-nozzle 10. The water pouch 52 is invisibly provided at the inner side of the cap 51, and covered by a lining 55. By way of the a water conduit 34 hidden inside of the cap 51, the water reserved in the water pouch 52 can be led to the sprinkle-nozzle 10 at the front of the peak 56 for spraying out mist 60 in the front of the user's face (as shown in FIG. 11) to instantly cool down the heat. Accordingly, a cap with the purposes of sprinkling and cooling is accomplished.

In the cap 50 having a sprinkle-nozzle 10 at the peak 56, the sprinkle-nozzle 10 is provided with a water conduit 34 for connecting to the water pouch 52 which is provided with a water inlet 53 and a cap 54. The water inlet 53 extrudes out of the hole 57 at the top of the cap 50, such that when the user is outdoors, she/he may infuse water, such as drinking water carried therewith, to the water inlet 53 and close the cover 54. A battery case 61 filled with a battery 63 is provided at the peak 56 with an electric cord 64 connected to the sprinkle-nozzle 10. As the integral sprinkle-nozzle 10 is lightweight, application thereof to the cap would not cause any burden to the user.

Concluded above, the conductor-driving multi-hole micro sprinkle-nozzle according to the invention is tiny-sized, lightweight, water-saving, and applicable to a variety of purposes. Besides, it can be combined to a cap to obtain sprinkling and cooling objects, particularly suitable to outdoor sports in summer. By way of the water conduit, the water can be transmitted to the front end of the peak, and sprayed on the user's face to cool down heat, thereby enhancing the utility of a cap.

While certain novel features of this invention have been shown and described and are pointed out in the annexed Claims, it is not intended to be limited to the details above, since it will be understood that various omissions, modifications, substitutions and changes in the forms and details of the device illustrated and in its operation can be made by those skilled in the art without departing in any way from the spirit of the present invention.

Although specific embodiments have been illustrated and described, it will be obvious to those skilled in the art that various modifications may be made without departing from what is intended to be limited solely by the appended claims.

Waht is claimed is:

1. A conductor-driving multi-hole micro sprinkle-nozzle having a conducting vibrator and a water container, comprising:
the conducting vibrator is composed of a vibrating ring in the form of a hollow ring made of a conductive material, and a metal membrane made of a conductive film, the specific portion of which has sprinkling holes distributed in a manner of dot matrix; while the vibrating ring is adhered to the metal membrane, the dot matrix sprinkling holes will be arranged within the hollow portion of the ring; the vibrator composed of the vibrating ring and the metal membrane is installed to a pipe top of a water container to accomplish a sprinkle-nozzle.

2. A cap made with a conductor-driving multi-hole micro sprinkle-nozzle, comprising:
a cap, a water pouch and a sprinkle-nozzle; the water pouch being invisibly provided at the inner side of the cap, and being covered by a lining; by way of the a water conduit hidden inside of the cap, the water reserved in the water pouch being led to the sprinkle-nozzle at the front of the cap peak; while the water pouch is provided with a water inlet extruding out of the top of the cap, and a cover, the cap peak is provided with a battery case which is exteriorly provided with a power switch, and interiorly installed with a battery, such that the power being connected from the battery case to the sprinkle-nozzle to accomplish a cap having the effect of sprinkling and cooling.

3. The cap made with a conductor-driving multi-hole micro sprinkle-nozzle according to claim 2, wherein the water inlet and cover of the water pouch are provided at the top of the cap.
